(19) United States
(12) Patent Application Publication
(10) Pub. No.: US 2007/0028849 A1
(43) Pub. Date: Feb. 8, 2007

(54) Aquaculture device

(76) Inventor: Peter Kvietelaitis, Clifton Springs (AU)

Correspondence Address: Robert C Klinger;Jackson Walker, Suite 600, 2435 North Central Expressway, Richardson, TX, 75080, US

(21) Appl. No.: 10/568,856

(22) PCT Filed: Sep. 10, 2004
(86) PCT No.: PCT/AU04/01238

§ 371 Date: Feb. 16, 2006

(30) Foreign Application Priority Data
Sep. 12, 2003 (AU) 2003904988

(51) Int. Cl. A01K 61/00

(52) U.S. Cl. 119/237

(57) ABSTRACT

An aquaculture device (34) including a body (38), said body (38) having at least one inwardly tapered slot (46) for receiving at least one elongate support means (12). The at least one elongate support means (12) being adapted to be inserted through said body (38) into said at least one inwardly tapered slot (46) and, in use, to be wedged between opposed side (48,50) of said at least one inwardly tapered slot (46) in order to attach said aquaculture device (34) at a predetermined location on said at least one elongate support means (12).

### FIELD OF THE INVENTION

The present invention relates to a device for use in the aquaculture farming industry, and relates particularly, though not exclusively, to a device which can be readily attached to suspended growing lines for aquatic farming of molluscs.

### BACKGROUND OF THE INVENTION

With increased demand for high quality produce, the aquaculture farming industry has developed smarter and more reliable techniques for culturing and harvesting marine life. Mussels, like other marine life, were historically harvested from the wild. However, as stocks have diminished, new methods of farming mussels have evolved. A common mussel farming method now in vogue utilises growing lines, such as ropes, nets, or the like, which are suspended below the surface of the water in order to collect seed mussels, which attach themselves to the lines in order to grow. After some time seed mussels collect on these lines in dense clusters, in fact at a density which is too large to allow the mussels to mature properly. At this point a mussel farmer may withdraw the lines from the water for harvesting and may then separate, de-clump, grade and inject the immature mussels into a mesh sock, net or the like which can sometimes surround a growing line. This process facilitates mussel attachment at a more appropriate density to assist the growth of mussels when they are re-introduced into the water. The mesh sock, which is usually perishable, provides a greater surface area for the mussels to attach to as they grow. Over time mussels grow radially outwardly through the mesh sock, to a size which can be several inches long.

As mussels increase in size, those closest to the growing line rely on support from the growing line itself, by attaching themselves thereto, whilst those disposed radially outwardly thereof rely on attachment to other mussels below them for support. If a mesh sock is utilised, mussels in the vicinity thereof can rely on this sock for support. If the sock is perishable, mussels can only initially rely on the sock for support After the sock disintegrates, mussels in that vicinity can only rely on support from those mussels beneath them. It is at this point that the entire mussel crop is reliant on the foothold of those mussels (the supporting mussels) that have directly attached themselves to the growing line. The number of mussels that can actually attach themselves directly to a growing line is dependant on the diameter or surface area of the growing line itself. It thus becomes evident that, as mussels grow and hence weight increases, if supporting mussels lose their foothold significant losses of crop can occur as large clusters of mussels fall away from the growing line.

Furthermore, as heavily laden mussel growing lines are immersed in water, the water itself serves to create a buoyancy effect for the mussels that are attached to the growing lines. However during harvest the mussel growing lines are lifted out of the water, meaning this buoyancy effect is lost. This loss of buoyancy means additional weight needs to be supported, and can result in a significant increase in the losses associated with mussels falling away from the lines.

Losses associated with mussels peeling off or falling away from growing lines will hereinafter generally be referred to as the “slide off effect”.

To minimise losses associated with the slide off effect many methods have been employed in the past. One such method has been to provide additional support to mussels on a growing line, through the insertion of a series of skewers or rods. These skewers, usually wooden, are inserted at spaced intervals through the perishable net, between the mussels and through the growing line (which provides the secure attachment). This results in a protrusion extending horizontally from either side of the vertically suspended growing line. These protrusions assist in supporting mussels from slide off by providing a greater attachment area for the mussels, being supported directly in the vicinity of the skewers.

Although widely adopted by mollusc farmers, the skewer method is generally considered to only provide marginal improvement in terms of reduction of the slide off effect. The following is a discussion of the limitations of the skewer method considered most relevant to the present invention.

A skewer tip is required to be sharp prior to insertion to facilitate ease of application through a growing line. Skewers are not normally re-usable, because tips become blunt after insertion. Plastics material skewers are rarely used as their tips become blunt far easier than alternatives. Traditionally, wooden skewers are used and are considered throw-away items after use. A problem with wooden skewers is that, over time and when immersed in water, they tend to become soft due to water absorption and decay and are prone to fail (break) when their effectiveness is most required (at or just prior to harvest).

As skewers are required to traverse a growing line to facilitate secure attachment thereto, traditionally skewers have only been “pencil-like” in design. This design requirement has meant that the skewers which have been utilised are only able to provide limited additional surface area support for the mussels. A preferred flat design skewer has not readily been used due to the difficulty involved in inserting the same through a growing line. To compensate for the lack of surface area provided by a single skewer, previous attempts have included the introduction of a number of skewers placed radially around the growing line, an inch or so apart, at sections along the growing line. This process has proven successful, however the application of multiple skewers in a small area is a tedious, costly and time-consuming exercise and as such has not been widely adopted.

A method for compensating for the lack of additional support area provided by a single skewer is described in U.S. Pat. No. 6,520,116, of Jefferds, Ian W. This method utilises a planar support plate or disc which is adapted to provide a large horizontal support surface for mussels when attached to a growing line. These plates or discs have a slot for receiving a growing line and a skewer-like projection attached thereto, projecting into and parallel with the slot, to be inserted through the growing line to facilitate attachment thereto. Essentially these plates rely on known skewer principles, in that they utilise a skewer for attachment to a growing line and, as such, suffer from the same inherent problems associated with insertion of a skewer through a growing line. Where these plates differ from the traditional skewer is that the additional support is provided by way of a plate making up one of the horizontal protrusions, instead of both protrusions simply being respective protruding sides of a skewer.

A further problem associated with the skewer method is that the nature of the insertion of a skewer to a growing line does not lend itself to automation of the application process. In cases where a mesh sock is used in combination with a growing rope, a person attempting to locate a skewer is required to find an encased, sometimes visually hidden and, more often than not, growing rope that is not centrally located within the sock. The skewer then needs to be inserted through the rope, preferably substantially centrally and horizontally to the rope. This task is usually performed manually and the aim of central and horizontal insertion is not always easy to achieve.

Further still, mussel growing lines themselves usually need to be specifically designed so as to facilitate manual insertion of the skewers which have been chosen for a particular application. The need for purpose-designed growing lines can increase costs associated with any harvesting operation.

Another problem associated with the skewer method, or devices which utilise a skewer for attachment to a growing line, such as Jefferds, is that, due to the design of a skewer, when it is inserted through a growing line it tends to rotate within the growing line itself. In the context of a skewer providing support on its own, or in combination with a number of skewers inserted in cooperation with one another, this rotation can itself induce the slide off effect. If a number of mussels attach themselves to a skewer on an upper surface and/or outwardly therefrom, the skewer may rotate to a point where the mussels are hanging down. If a cluster of mussels now hanging down is of sufficient weight, supporting mussels may not be able to maintain attachment of clusters to the growing line, causing those mussels to dislodge and become lost. The rotation of a skewer negates the usefulness of applying encompassing support plates or discs to the skewer protrusions (Jefferds). Since even weight distribution on the plates cannot be guaranteed, uneven weight accumulation on the encompassing plates or the like can induce crop loss rather than prevent loss. Furthermore, slight weight distribution problems on one plate can have a catastrophic effect on other plates, resulting in mussels sliding off the growing line, particularly as it is being raised for harvesting,

Despite the aforementioned limitations, a major attraction to mollusc farmers with regard to using a skewer is the ease with which a skewer can be removed from a growing line after a crop has been harvested. This is said to be an important requirement to the aquaculture farmer of any support attachment means. The conventional skewer achieves relatively easy detachment since, when a skewer is pulled out of a growing line, any marine growth attached to the protrusion of the skewer that is being drawn through the growing line for removal becomes detached by the application of removal force to the skewer. The growing line serves as a resistance to any marine growth during this action and simply strips marine life off the surface of the skewer as it is withdrawn through the hole in the growing line. If marine growth attachment is too firm for dislodgment a skewer can simply be broken off at the growing line, in turn permitting removal without hindrance. However, if barbs or the like are provided on plate type support structures utilising skewer-like projections, as in the Jefferds patent, the benefit of simplistic detachment is lost.

An alternate method of attaching plate-like support structures to growing lines is described in U.S. Pat. No. 6,578,523, of Gagnon, Gilles. Instead of using a skewer-like projection for attachment, as is the case in the Jefferds patent, this patent provides a device which utilises a clip arranged within an aperture, at the centre of the device, to facilitate attachment of the device to a growing line. This clip is cylindrical in shape and, in use, has a diameter slightly smaller than the diameter of the growing line for gripping the latter when attached thereto. The clip has an opening bordered by outwardly diverging, resilient arms. During insertion of a growing line the arms flex outwardly into generally V-shaped recesses and return to the rest position in which the rope is clamped in the clip. This device overcomes the problems associated with having to skewer a growing line, and instead proposes the use of a clip that resiliently clamps around the circumference of a growing line to provide attachment. The design of the clip is such that mussels have to be first parted or removed from the growing line in order to affix the device to an exposed section thereon. If the clip is not secured around an unhindered line attachment cannot occur, since the diameter of the clip is smaller than the growing line. Thus, if marine life is present in the area of the clip, the device will not be able to maintain secure attachment. Although it may be said that the initial attachment to the growing line may be simplified (as compared with the skewer method) by the clip arrangement, it is doubtful whether the resilient clip will provide sufficient secure attachment to the growing line as weight increases on the support plate. It is believed that the support plate will slide down the growing line within the clip as mussel weight increases with growth on the device. Furthermore, when marine growth occurs in a critical area of the clip attachment means, specifically around the resilient arms, it is believed that over time the weight of growth could render the attachment means ineffective by inducing release of the clamping force provided by the clip on the growing line. Growth in the area of the clip of this device may also render detachment of the device difficult or tedious to achieve.

### SUMMARY OF THE INVENTION

It is therefore an object of the present invention to provide an aquaculture device having improved attachment means to facilitate relatively simple attachment of the aquaculture device to a growing line.

A further object of the present invention is to provide an aquaculture device having improved attachment means which overcomes one or more of the limitations described above relating to the conventional skewer attachment means and/or those of the prior art.

According to the present invention there is provided an aquaculture device including a body, said body having at least one inwardly tapered slot for receiving at least one elongate support means, whereby said at least one elongate support means is adapted to be inserted through said body into said at least one inwardly tapered slot and, in use, to be wedged between opposed sides of said at least one inwardly tapered slot in order to attach said aquaculture device at a predetermined location on said at least one elongate support means.

Preferably said at least one elongate support means is selected from one or more of the following: any suitable growing rope, any suitable growing rope that is socked with a suitable mesh net and/or any suitable sock-like mesh net.

It is also preferred that said opposed sides of said at least one inwardly tapered slot are at least initially narrow in width so as to provide a means, in use, for slicing or parting any marine growth present in the vicinity of an attachment area on said at least one elongate support means. Similarly it is also preferred that said at least one inwardly tapered slot is suitably shaped such that, in use applications where said at least one elongate support means is embodied as a growing rope that is socked with a mesh net, said at least one inwardly tapered slot can simultaneously compress said mesh net, separate any marine life present in the attachment area and locate said growing rope within said net in order to facilitate attachment thereto.

It is further preferred that said body of said aquaculture device has a configuration, or is further attached to an additional body that has a configuration, selected from one or more of the following group: a planar support plate, a disc-shaped support plate, a support structure incorporating a series of protrusions, a support structure incorporating a ring-like support area, a cage-like structure, and/or any suitable combination thereof.

In a practical preferred embodiment said at least one elongate support means is adapted to be suspended below the surface of the water in order to provide an attachment surface or support for molluscs or the like during their growth. In this practical growing environment at least one aquaculture device incorporating a single inwardly tapered slot can be attached to at least one elongate support means at any fixed location. The body of said at least one aquaculture device provides additional support area for molluscs to attach to or be supported as they grow.

In an alternative practical preferred embodiment more than one elongate support means may be suspended in cooperation with each other below the surface of the water in order that at least one aquaculture device made according to the invention incorporating more than one inwardly tapered slot can be attached to each of said more than one elongate support means simultaneously. In a preferred embodiment said at least one aquaculture device incorporating said more than one inwardly tapered slot is a cage or pod-like structure adapted to provide a culture area for marine life suitable for harvesting.

In yet a further practical embodiment said at least one inwardly tapered slot can be open at one end to a peripheral edge of said body to enable ease of introduction of said at least one elongate support means into said at least one inwardly tapered slot, or can be closed at both ends such that said at least one elongate support means must be threaded into said at least one inwardly tapered slot.

In yet a further practical embodiment said at least one inwardly tapered slot of said aquaculture device is inclined relative to said at least one elongate support means such that an apex of said at least one inwardly tapered slot is positioned higher relative to a broader end thereof.

Further practical embodiments include providing additional means, such as cleats, teeth, clips, hooks or the like, positioned on or near at least one of said opposed sides of said at least one inwardly tapered slot, said additional means acting as retaining or locking means to assist the wedging attachment action provided by the taper arrangement of said at least one inwardly tapered slot. Further still said aquaculture device may include at least one skewer-like projection, which may include barbs or the like, positioned within or near said at least one inwardly tapered slot such that, when said at least one elongate support means is wedged between said opposing sides of said at least one inwardly tapered slot, said at least one elongate support means is additionally skewered by said at least one skewer-like projection. The skewering action is automatically provided by force applied relative to said aquaculture device on said at least one elongate support means into said at least one inwardly tapered slot.

In yet a further practical embodiment said aquaculture device includes at least one pair of opposed tapered cleats, integral with or attached to said opposed sides of said at least one inwardly tapered slot. Said at least one pair of opposed tapered cleats may be adapted, in use, to provide a means of assisting dislodgment and removal of said aquaculture device from said at least one elongate support means by slicing or parting any marine growth present in the detachment area relative to said aquaculture device. Said at least one pair of opposed tapered cleats are preferably at least initially narrow in width in the removal direction, in order to assist removal of said aquaculture device.

In yet a further practical embodiment said aquaculture device can be applied to said at least one elongate support means by an automated application process. In mollusc harvesting operations a plurality of said aquaculture devices are preferably mechanically applied in an automated process to said at least one elongate support means simultaneously with the process of socking molluscs in a growing line including a mesh net. It is preferred that said aquaculture device may be detached from said at least one elongate support means by any suitable automated process. In the case of such an automated removal process, said aquaculture device may include said at least one pair of opposed tapered cleats (as previously defined), in order to assist the automated removal of said aquaculture device.

According to a further aspect of the present invention there is provided a method of attaching at least one aquaculture device to at least one elongate support means, said at least one aquaculture device having a body including at least one inwardly tapered slot for receiving said at least one elongate support means therein, said method including the steps of providing said at least one elongate support means; providing said at least one aquaculture device; and attaching said at least one aquaculture device to said at least one elongate support means at any predefined fixed location, wherein said at least one aquaculture device is secured to said at least one elongate support means by inserting said at least one elongate support means into said at least one inwardly tapered slot and wedging said at least one elongate support means between opposing sides of said at least one inwardly tapered slot.

According to yet a further aspect of the present invention there is provided an aquaculture growing assembly, including: at least one elongate support means to support and/or grow thereon a plurality of molluscs; and at least one aquaculture device having a body including at least one inwardly tapered slot for receiving said at least one elongate support means therein; whereby said at least one elongate support means is adapted to be inserted through said body into said at least one inwardly tapered slot and, in use, to be wedged between opposed sides of said at least one inwardly tapered slot in order to attach said aquaculture device at a predetermined location on said at least one elongate support means, and wherein said at least one aquaculture device is/are adapted to provide an attachment surface and/or support area for supporting said molluscs as they grow.

### BRIEF DESCRIPTION OF THE DRAWINGS

In order that the invention may be more clearly understood and put into practical effect there shall now be described in detail preferred constructions of an aquaculture device in accordance with the invention. The ensuing description is given by way of non-limitative example only and is with reference to the accompanying drawings, wherein:

FIG. 1 is a side view of a mollusc culture growing arrangement showing growing lines suspended beneath the surface of the water in order to provide support for molluscs as they grow;

FIG. 2a is a perspective view of an aquaculture device made in accordance with a first preferred embodiment of the invention and suitable for application to the growing lines of the mollusc growing arrangement shown in FIG. 1, the aquaculture device being shown positioned ready for attachment to a growing line which is represented in cross-section;

FIG. 2b is a view similar to that of FIG. 2a, showing the aquaculture device being further applied to the growing line of FIG. 2a;

FIG. 2c is a view similar to that of FIGS. 2a & 2b, showing in cross-section the aquaculture device attached to the growing line;

FIG. 3 is a perspective view of the aquaculture device of FIGS. 2a to 2c, shown attached to an alternative growing line application;

FIG. 4a is a cross-sectional plan view of the aquaculture device of FIGS. 2a to 2c and 3, shown attached to yet a further alternative growing line application;

FIG. 4b is a cross-sectional side view of the aquaculture device of FIG. 4a, taken along and in the direction of arrows 4b-4b;

FIG. 5 is a perspective view of an aquaculture device made in accordance with a second preferred embodiment of the invention and suitable for application to the growing lines of the mollusc growing arrangement shown in FIG. 1, the aquaculture device shown attached to a growing line;

FIG. 6 is a perspective view of an aquaculture device made in accordance with a third preferred embodiment of the invention and suitable for application to the growing lines of the mollusc growing arrangement shown in FIG. 1, the aquaculture device shown attached to a growing line;

FIG. 7 is a cross-sectional plan view of the aquaculture device of FIG. 5;

FIG. 8 is an enlarged cross-sectional plan view of an attachment area of an aquaculture device made in accordance with a fourth preferred embodiment of the invention;

FIG. 9 is an enlarged cross-sectional plan view of an attachment area of an aquaculture device made in accordance with a fifth preferred embodiment of the invention;

FIG. 10 is an enlarged cross-sectional plan view of an attachment area of an aquaculture device made in accordance with a sixth embodiment of the invention;

FIGS. 11a to 11c show enlarged cross-sectional plan views of an attachment area of an aquaculture device made in accordance with a seventh preferred embodiment of the invention, each Figure representing the aquaculture device in various stages of operation;

FIG. 12a is a cross-sectional perspective view of an aquaculture device made in accordance with an eighth preferred embodiment of the invention and suitable for automated application to the growing lines of the mollusc growing arrangement shown in FIG. 1;

FIG. 12b is a cross-sectional plan view of the aquaculture device of FIG. 12a, shown attached to a growing line;

FIG. 12c is a perspective view of the aquaculture device of FIGS. 12a & 12b, shown in position ready for attachment to an alternative growing line application to that of FIG. 12b, the alternative growing line being represented in cross-section;

FIG. 12d is a cross-sectional side view of the aquaculture device of FIGS. 12a to 12c, showing the aquaculture device attached to the growing line of FIG. 12c;

FIG. 13a is a cross-sectional perspective view of an aquaculture device made in accordance with a ninth preferred embodiment of the invention and suitable for application to the growing lines of the mollusc growing arrangement shown in FIG. 1, the aquaculture device shown attached to a growing line;

FIG. 13b is a cross-sectional perspective view of an aquaculture device made in accordance with a tenth preferred embodiment of the invention and suitable for application to the growing lines of the mollusc growing arrangement shown in FIG. 1, the aquaculture device shown attached to a growing line;

FIG. 14a is a cross-sectional perspective view of an aquaculture device made in accordance with an eleventh preferred embodiment of the invention and suitable for application to the growing lines of the mollusc growing arrangement shown in FIG. 1, the aquaculture device shown attached to a growing line;

FIG. 14b is a perspective view of an aquaculture device made in accordance with a twelfth preferred embodiment of the invention and suitable for application to the growing lines of the mollusc growing arrangement shown in FIG. 1, the aquaculture device shown attached to a growing line;

FIG. 15a is a perspective view of an aquaculture device made in accordance with a thirteenth preferred embodiment of the invention and suitable for application to the growing lines of the mollusc growing arrangement shown in FIG. 1, the aquaculture device shown attached to a growing line; and

FIG. 15b is an enlarged sectional view of one attachment area of the aquaculture device of FIG. 15a, as circled in FIG. 15a.

### DETAILED DESCRIPTION OF THE PREFERRED EMBODIMENTS

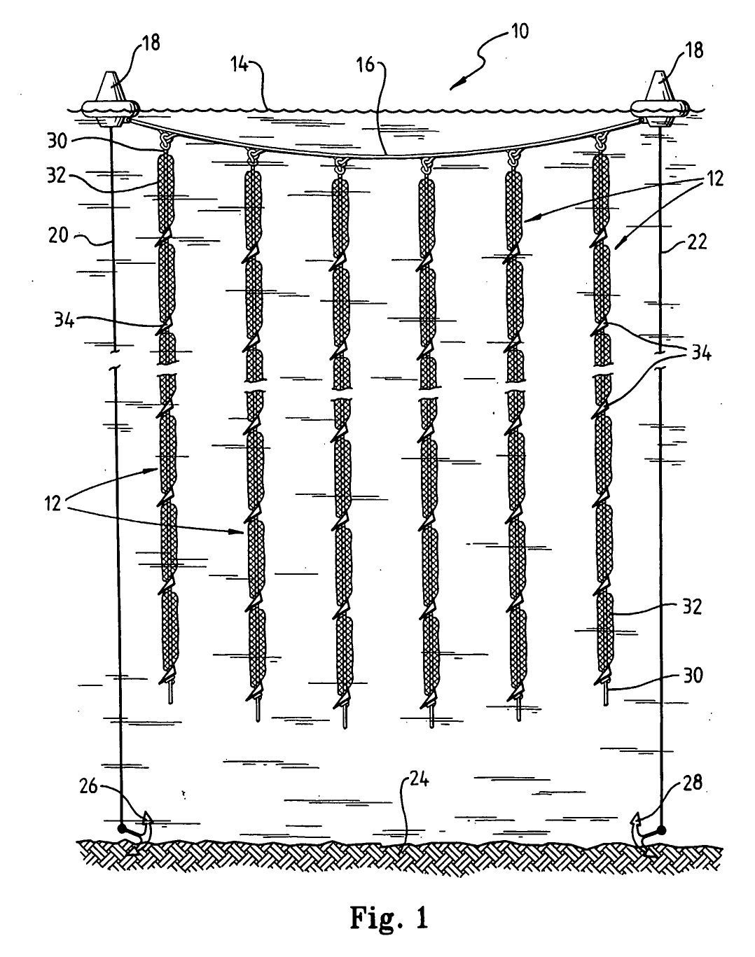

Referring now to the drawings, wherein like reference numerals correspond to like parts throughout, in FIG. 1 there is shown a mollusc growing arrangement 10 suitable, for example, for growing mussels. Mollusc growing arrangement 10 includes a plurality of growing lines 12 adapted to be vertically suspended below the surface of the water 14 to provide a series of harvesting support media for mollusc cultivation. Growing lines 12 are suspended from a substantially horizontal support line 16. Support line 16 is suspended beneath the water surface 14 between a pair of buoys 18. Two substantially vertical support lines 20,22, each anchored to the seabed 24 at anchor points 26,28, are attached to respective buoys 18 in order to maintain the overall mollusc growing arrangement 10 at a chosen location.

Growing lines 12 each consist of a growing rope 30 which has been socked with a mesh net 32. Although shown in mollusc growing arrangement 10 as each including growing rope 30 and mesh net 32, growing lines 12 may be embodied as a growing rope 30 or mesh net 32 used on their own. Similarly, growing lines 12 may consist of one or more alternative growing media (not shown), used on their own or in combination, and as such the invention is not intended to be limited to any specific example shown.

A general discussion of mussel cultivation utilising vertically suspended growing lines has already been provided in the initial paragraphs of this specification and is herein incorporated with reference to the present discussion.

Shown attached to growing lines 12 (FIG. 1) and positioned at spaced-apart locations thereon are a plurality of aquaculture devices 34. In mollusc growing arrangement 10, aquaculture devices 34 are embodied as support structures which are adapted to provide additional support for mussels 36 (not shown in FIG. 1) to attach to, as they grow. In a harvesting operation, when aquaculture devices 34 are attached to growing lines 12 and placed in the environment of mollusc growing arrangement 10, mussels 36 are not only able to attach themselves to other mussels 36, growing ropes 30 and mesh nets 32, as is conventional, but can also attach themselves to aquaculture devices 34 for additional support. Aquaculture devices 34 provide platform-like supports for mussels 36 that emanate from the vertically suspended growing lines 12. This platform-like attachment of mussels 36 helps to reduce losses associated with the slide off effect.

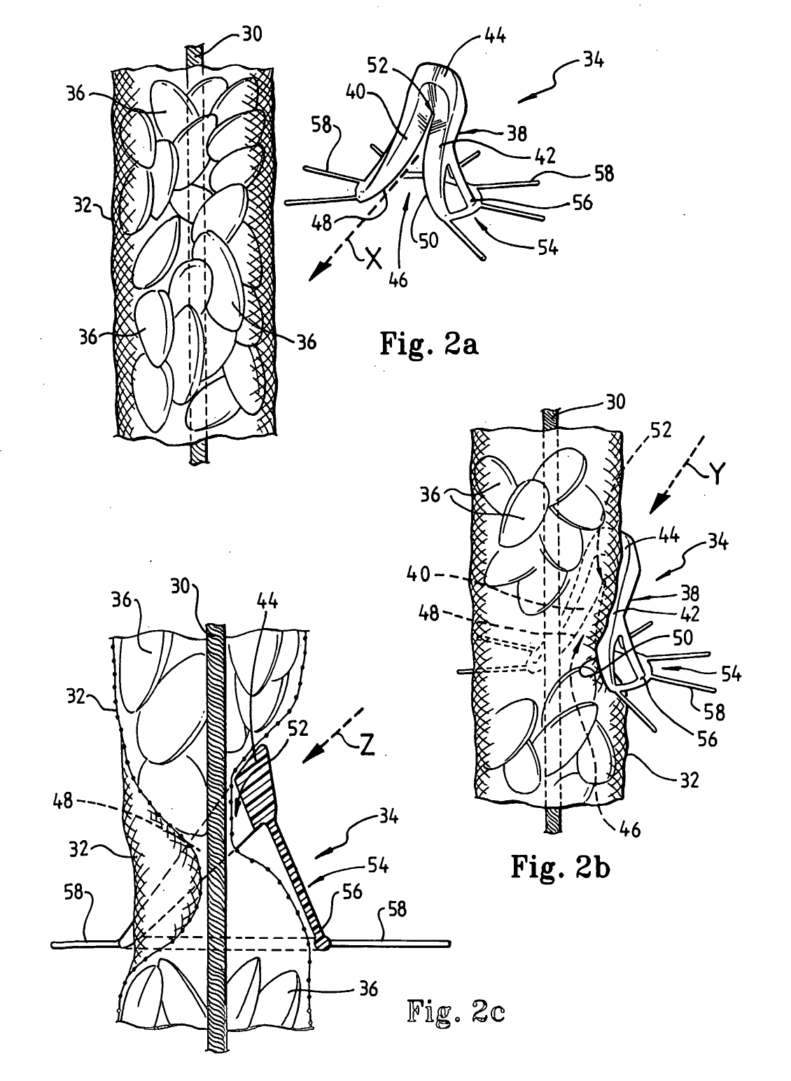

An aquaculture device 34 made in accordance with a first preferred embodiment of the invention, as seen in FIG. 2a, includes a body 38 having two angularly-disposed arm portions 40,42 joined at an intersection portion 44. Defined between arm portions 40,42 is an inwardly tapered slot 46, having opposed slot sides 48,50 and an apex 52 positioned relative to intersection portion 44. In use, tapered slot 46 is adapted to receive and engage growing line 12 in order to facilitate attachment thereto. When growing line 12 is introduced into inwardly tapered slot 46 and forced towards apex 52, growing line 12 is wedged into engagement with opposed slot sides 48,50, providing secure attachment of aquaculture device 34 to growing line 12.

Aquaculture device 34 also includes a support portion 54 which, in a first preferred aspect, includes a support skirt 56 having a plurality of support projections 58 emanating therefrom. In use, and when attached to growing line 12, both body 38 and support portion 54 may provide additional support area for mussel attachment to that provided by growing line 12.

Although shown having tapered slot 46 inclined relative to that plane perpendicular to the vertically suspended growing line 12, it should be understood that aquaculture device 34 may incorporate an inwardly tapered slot 46 which is substantially perpendicular to growing line 12. As such, attachment of aquaculture device 34 to growing line 12 can occur by utilising a tapered slot 46 set at any appropriate angle. It should also be understood that the choice of configuration of support portion 54 is dependant on the intended use of aquaculture device 34. Similarly support skirt 56 and projections 58, as shown as a preferred design of support portion 54, may assume many different configurations and still achieve the same desired result. For example support skirt 56 and projections 58 may be designed such that they completely encircle aquaculture device 34 and enclose tapered slot 46 opposite apex 52. In this alternative embodiment introduction of growing line 12 into tapered slot 46 could occur by threading growing line 12 into tapered slot 46.

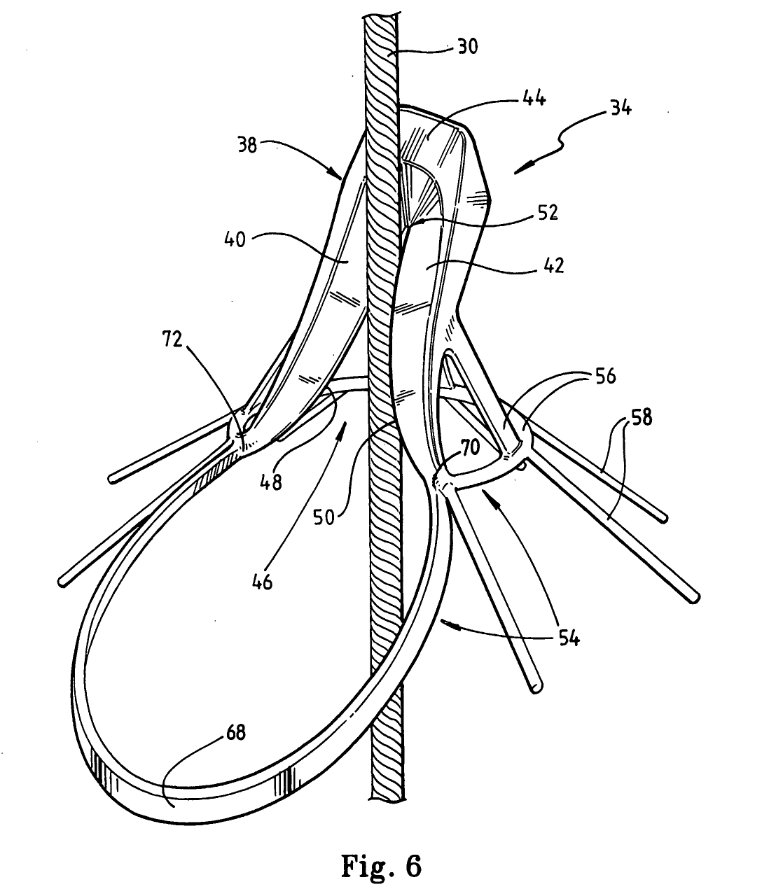

In the embodiments of FIGS. 2a to 4b, projections 58 of support portion 54 are arranged substantially horizontally with respect to the vertically suspended growing line 12. In an alternative embodiment (see for example FIG. 6) projections 58 may be attached to support skirt 56 at an angle of approximately 45° to growing line 12 to provide a cone-like structure around growing line 12. A cone-like arrangement of projections 58 is expected to provide far more effective attachment of clumped mussels 36 around growing line 12 and aquaculture device 34 at a point which is larger in area as compared with a horizontal arrangement of projections 58 as is shown in the drawings.

In an especially preferred form, the peripheral edges of opposed slot sides 48,50 of tapered slot 46 are narrow in cross-section (at least initially) and may be sharp or rounded to assist in providing the required wedged engagement of growing line 12 within tapered slot 46. Peripheral opposed slot sides 48,50 induce a significant compression force at the points of contact with growing line 12, requiring little comparative forward force. These opposed slot sides 48,50 also provide a means by which growing line 12 can be temporarily gripped within tapered slot 46 until such time as sufficient force is applied to aquaculture device 34 in order to wedge growing line 12 into engagement. Opposed slot sides 48,50 serve as rails for growing line 12, which is compressed at the points of engagement with opposed slot sides 48,50 and helps to drive growing line 12 further into tapered slot 46 as force is applied.

A process of attaching aquaculture device 34 to growing line 12 is now described with reference to the embodiment of FIGS. 2a to 2c. In a first stage of application (FIG. 2a), aquaculture device 34 is positioned relative to growing line 12 such that growing line 12 may be introduced into inwardly tapered slot 46 when aquaculture device 34 is moved in the direction of arrow x. As growing line 12 is moved inwardly of tapered slot 46 (FIG. 2b), mesh net 32 compresses about growing rope 30, and at about the same time mussels 36 in the vicinity of opposed slot sides 48,50 are parted or sliced by the force applied to aquaculture device 34 in the direction of arrow y. Opposed slot sides 48,50 and angled arm portions 40,42 clear a track to further provide a path for aquaculture device 34 to facilitate attachment. As further force is applied in the direction of arrow z (FIG. 2c) both growing rope 30 and mesh net 32 are forced into wedged engagement with opposed slot sides 48,50 at or near apex 52. This wedged engagement facilitates attachment of aquaculture device 34 at a fixed location on growing line 12.

When attached to growing line 12 (FIG. 2c), body 38 and support portion 54, including support skirt 56 and projections 58, provide mussel support area in addition to that provided by growing line 12. Mussels 36 can attach to projections 58 and to each other, which over time bridges the gaps between adjacent projections 58, providing firm, radial attachment of mussels 36 at the point of attachment of aquaculture device 34 to growing line 12. Radially attached mussels 36 substantially reduces slide off effect losses.

Detachment of aquaculture device 34 from growing line 12 may occur by applying appropriate force in the opposite direction to arrows z,y,x as shown in FIGS. 2c, 2b, & 2a. Firmly attached mussels 36 present in the vicinity of aquaculture device 34 are either left on growing line 12 or remain attached to aquaculture device 34, in which case they can be removed at a later stage.

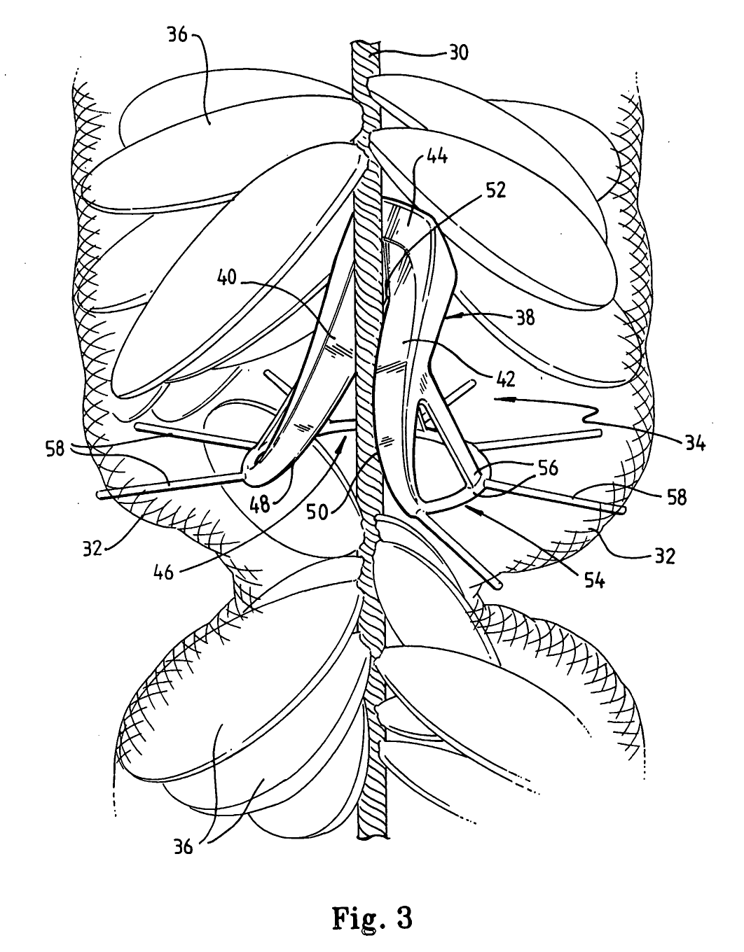

Referring to FIG. 3, aquaculture device 34 of FIGS. 2a to 2c is again shown attached to a growing line 12. In this embodiment aquaculture device 34 has first been attached to a growing rope 30, in the same manner as previously described, and has later been socked with mesh net 32. The representation of the application of aquaculture device 34 to growing line 12 in this configuration is intended to illustrate that aquaculture device 34 can be applied to varying growing line 12 arrangements.

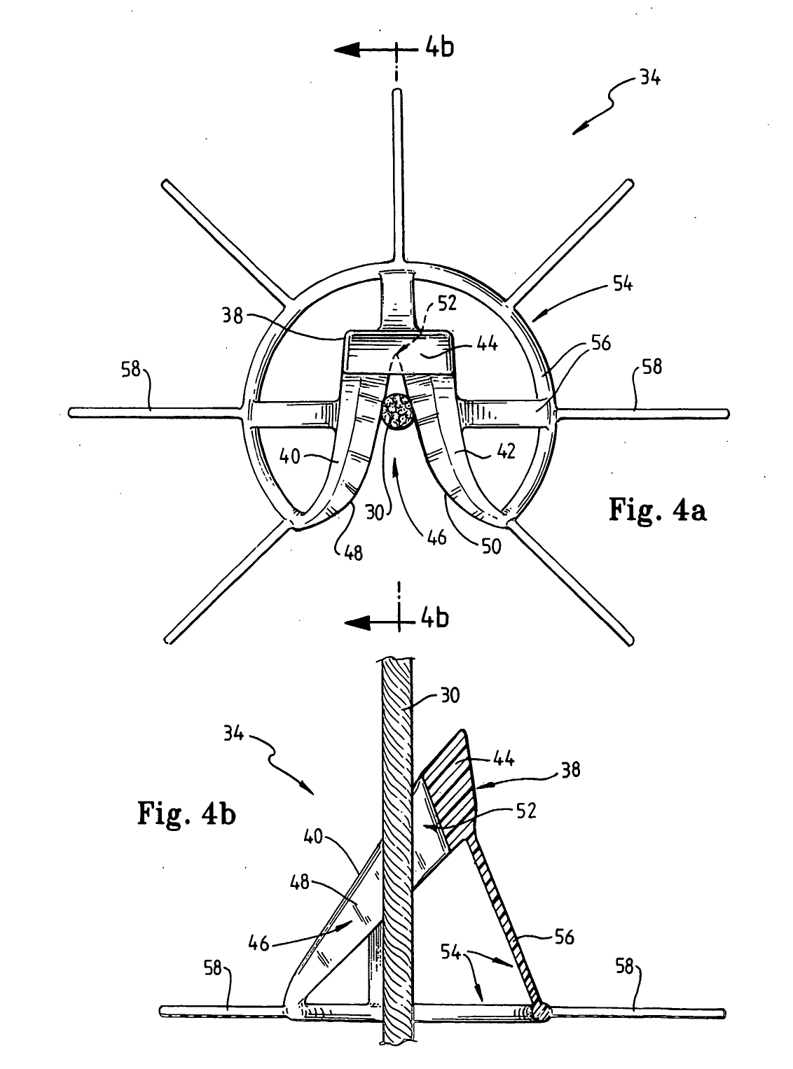

In FIGS. 4a and 4b there are shown alternative views of the aquaculture device 34 of FIGS. 2a to 3, shown attached to a growing rope 30 used on its own as a growing line 12. In FIG. 4a it can be seen that growing rope 30 has been wedged into engagement with opposed slot sides 48,50, near apex 52. Referring to FIG. 4b it can be seen that, due to the preferred inclined arrangement of inwardly tapered slot 46, as further force (by way of manually induced force or force resulting from mussel growth) is applied to aquaculture device 34 downwardly of vertically suspended growing rope 30, growing rope 30 will be further wedged into inwardly tapered slot 46 relative to apex 52. Thus, the preferred inclined arrangement of inwardly tapered slot 46 facilitates secure attachment of aquaculture device 34 to growing line 12.

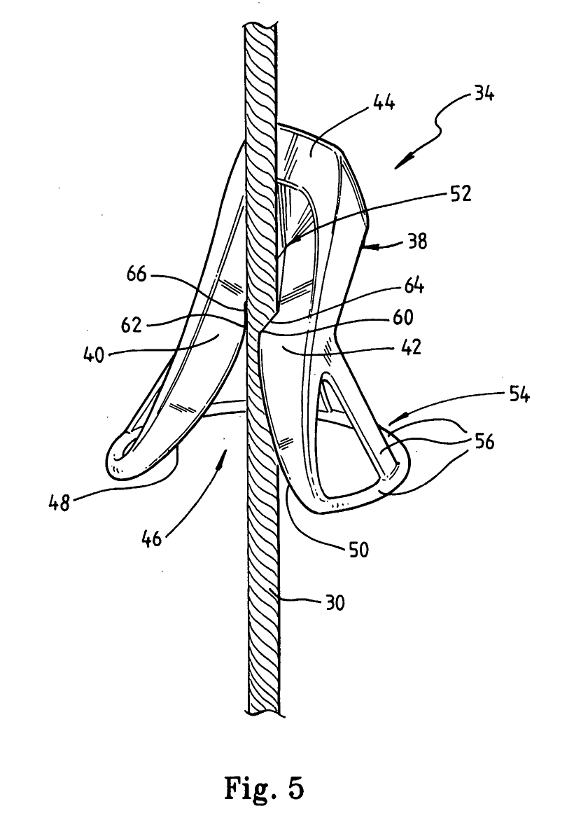

An aquaculture device 34, made in accordance with a second preferred embodiment of the invention, is shown in FIG. 5 attached to a growing rope 30, used on its own as growing line 12. In this embodiment support portion 54 of aquaculture device 34 is constructed as including only a support skirt 56, in order to provide mussel attachment thereto. This preferred aquaculture device 34 includes an inwardly tapered slot 46, having opposed slot sides 48,50, which include inwardly opposed raised sections 60,62. These raised sections 60,62 are cleat-like projections which may be formed integral with angled arms 40,42 and opposed slot sides 48,50. Similar raised sections 60,62 may be separate integers which may be permanently attached within tapered slot 46 or may be removably attached therein. The addition of raised sections 60,62 within inwardly tapered slot 46 creates a type of taper within a taper configuration, wherein growing rope 30, when introduced into tapered slot 46, must first pass through opposed raised sections 60,62 and then into wedged engagement with opposed slot sides 48,50 at or near apex 52. Raised cleat-like sections 60,62 have a number of benefits in terms of their application to aquaculture device 34. One benefit is that raised sections 60,62 serve to lock growing rope 30 within the uppermost taper section once growing rope 30 has passed through raised sections 60,62. This locking action can further assist aquaculture device 34 being dislodged by the additional force required to withdraw growing rope 30 back through raised sections 60,62. An attractive feature of utilising the cleat-like taper within a taper configuration provided by raised sections 60,62 is that a reverse taper can be provided by opposed reverse taper sides 64,66. If opposed reverse taper sides 64,66 are appropriately designed such that they are at least initially narrow at the first points of contact with growing rope 30, similar to those proposed for opposed slot sides 48,50, the action of removal of aquaculture device 34 can be assisted by a slicing or parting action provided by opposed reverse taper sides 64,66. Thus any marine growth which may be present in the detachment path of aquaculture device 34 can be sliced or parted in a reverse fashion to that previously described with reference to opposed slot sides 48,50 during application of aquaculture device 34.

An aquaculture device 34 made in accordance with a third preferred embodiment of the invention is shown in FIG. 6 attached to a growing rope 30 used on its own as a growing line 12. In this embodiment support portion 54 of aquaculture device 34 includes a plurality of projections 58 emanating from support skirt 56 and extending downwardly relative to the horizontal. A discussion of the benefits of inclined projections 58 has already been provided earlier in this specification.

In FIG. 6, support portion 54 also includes an additional large semi-circular support 68, extending and inclined downwardly from points 70,72 at the ends of angled arm portions 40,42 for providing additional support for molluscs or the like (not shown) when attached to growing rope 30 in a growing operation. Although shown as semi-circular in shape, additional support 68 may assume any suitable shape. For example additional support 68 may be square in shape as compared to circular as shown, or solid in design providing a planar plate-like support surface.

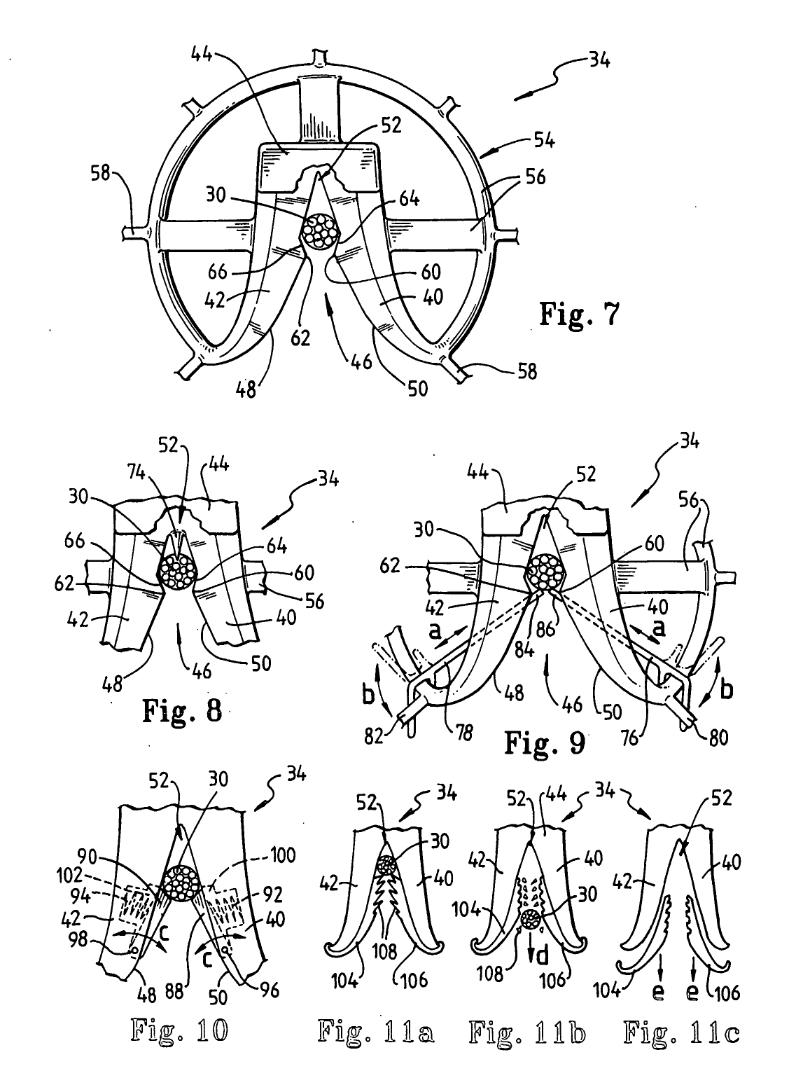

In FIG. 7 there is shown a plan view of an aquaculture device 34 similar to that of FIG. 5, but including a plurality of projections 58 emanating from support skirt 56. In this Figure it can be seen that growing rope 30 has been wedged into engagement with opposed slot side 48,50 of inwardly tapered slot 46 after having passed through raised sections 60,62. It can also be seen that, should growing rope 30 be removed from within inwardly tapered slot 46, the same must first pass back through raised section 60,62 which is assisted by opposed reverse taper sides 64,66 of raised sections 60,62.

An aquaculture device 34 made in accordance with a fourth preferred embodiment of the invention is shown in FIG. 8 attached to a growing rope 30 used on its own as a growing line 12. In this preferred arrangement a skewer-like spike 74 is arranged within tapered slot 46 at apex 52. The provision of spike 74 provides a means for at least partially skewering growing rope 30 when force is applied to aquaculture device 34, in order to wedge the same between opposed slot sides 48,50. By positioning spike 74 at apex 52, skewering of growing rope 30 will take place substantially centrally of growing rope 30. Previous conventional skewering methods have suffered due to the difficulty in inserting a skewer through a growing rope 30, which sometimes must be initially located within a mesh net 32. By using the tapered arrangement of the present invention in combination with spike 74, tapered slot 46 drives growing rope 30 into wedged engagement with opposed slot sides 48,50 and simultaneously skewers growing rope 30 at a location substantially centrally of growing rope 30.

The provision of spike 74 assists the wedging engagement provided by tapered slot 46 by additionally providing a means to prevent aquaculture device 34 from slipping relative to growing line 30 as weight is applied. Spike 74 may include barbs (not shown) or an arrow-head like extension (not shown) arranged thereon to additionally retain skewered engagement with growing line 30 after insertion through or into said line. Spike 74 and any barbs or arrow-head extension thereon may be designed for a one-use application and could break away when removal force is applied to aquaculture device 34. Similarly, spike 74 may be replaceable such that, after removal of aquaculture device 34, a new spike 74 may be fitted to aquaculture device 34 ready for re-use.

It should be understood that, although spike 74 is shown arranged at apex 52 of tapered slot 46, it may be positioned at other locations within or near tapered slot 46 and still provide skewering of growing row 30. Similarly, more than one spike 74 may be arranged at varying locations within or near tapered slot 46 in order to provide skewering of growing rope 30 at multiple locations.

An aquaculture device 34 made in accordance with a fifth preferred embodiment of the invention is shown in FIG. 9 attached to a growing rope 30 used on its own as a growing line 12. In this embodiment aquaculture device 34 includes a pair of locking arms 76,78 removably connected to support skirt 56, adjacent retaining projections 80,82, extending from support skirt 56 and terminating at locking arm ends 84,86 at a point adjacent raised sections 60,62. Locking arm ends 84,86 provide a barrier against removal of growing rope 30 when wedged into engagement with opposed slot sides 48,50 and past raised sections 60,62 relative to inwardly tapered slot 46.

In use, growing rope 30 may either be forced into tapered slot 46 and past locking arm ends 84,86, into wedged and locked engagement, or may be forced into wedged engagement within tapered slot 46 and later locked engagement by fitting locking arms 76,78 at a later stage. Locking arms 76,78 can be fitted or removed from aquaculture device 34 by correctly positioning each locking arm 76,78 in the direction of arrow a and then rotating the same relative to arrow b. Retaining projections 80,82, which may simply be support projections 58, are appropriately positioned such that they provide a means by which locking arms 76,78 can act to facilitate locking of the same thereon aquaculture device 34.

An aquaculture device 34 made in accordance with a sixth preferred embodiment of the invention is shown in FIG. 10 attached to a growing rope 30 used on its own as a growing line 12. In this embodiment, instead of fixed raised sections 60,62, aquaculture device 34 includes a pair of movable cleats 88,90 resiliently biased into inwardly tapered slot 46 by springs 92,94 and hinged by pins 96,98. Cleats 88,90 are embodied such that they can be moved, relative to arrows c, into cavities 100,102 against the force of biassed springs 92,94, and substantially flush with opposed slot sides 48,50 to facilitate insertion of growing rope 30 into wedged engagement within tapered slot 46. As growing rope 30 is forced into tapered slot 46, cleats 88,90 move into cavities 100,102 permitting growing rope 30 to pass therethrough and into wedged engagement with opposed slot sides 48,50 near or at apex 52. Removal of growing rope 30 can be achieved by applying an appropriate removal force on growing rope 30, or by depressing cleats 88,90 into cavities 100,102 and simultaneously withdrawing growing rope 30.

An aquaculture device 34 made in accordance with a seventh preferred embodiment of the invention is shown in FIGS. 11a to 11c, shown in various stages of application to a growing rope 30 used on its own as a growing line 12. In this embodiment aquaculture device 34 includes a pair of removable tapered insert jaws 104,106 having teeth 108 positioned thereon. Jaws 104,106 can be removably attached (FIG. 11a) by way of glue, clips or the like, to opposed slot side 48,50 within tapered slot 46. In FIG. 11a growing rope 30 is shown wedged into engagement with opposed slot sides 48,50 near to apex 52. Growing rope 30 may have passed through teeth 108 of jaws 104,106 to facilitate wedged engagement within tapered slot 46 or may have been wedged into engagement before jaws 104,106 were fitted to aquaculture device 34. When a removal force is applied (FIG. 11b) to growing rope 30 in the direction of arrow d, teeth 108 break away from jaws 104,106 allowing release of growing rope 30 from within tapered slot 46. Damaged jaws 104,106 can then be removed (FIG. 11c) by applying a removal force to jaws 104,106 in the direction of arrows e. Replacement jaws 104,108 can then be fitted prior to re-use of aquaculture device 34.

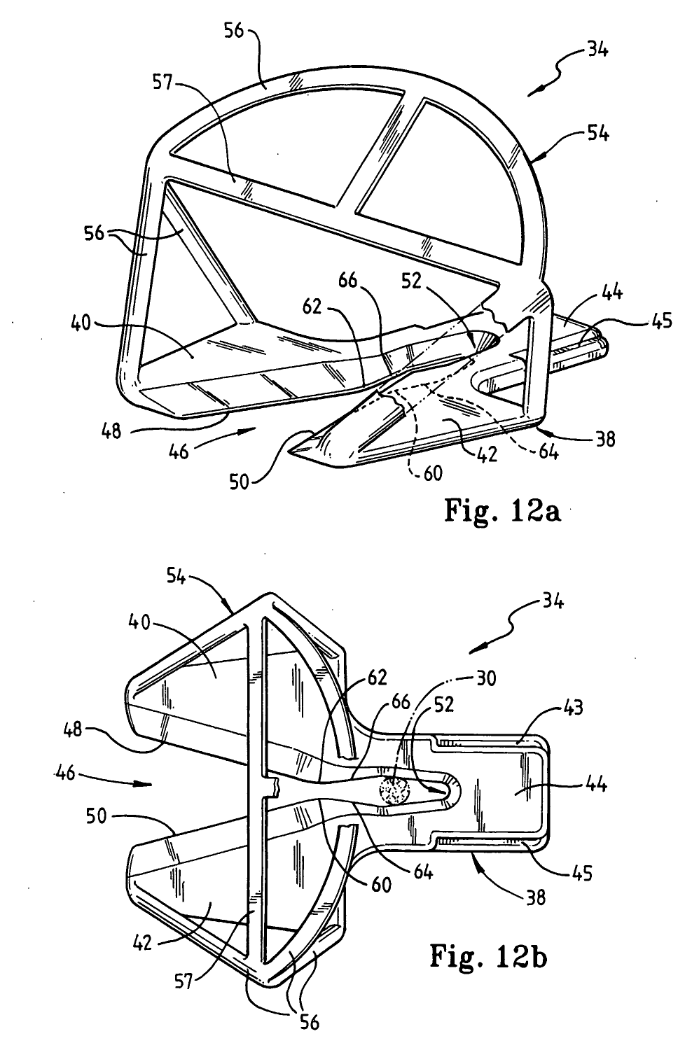

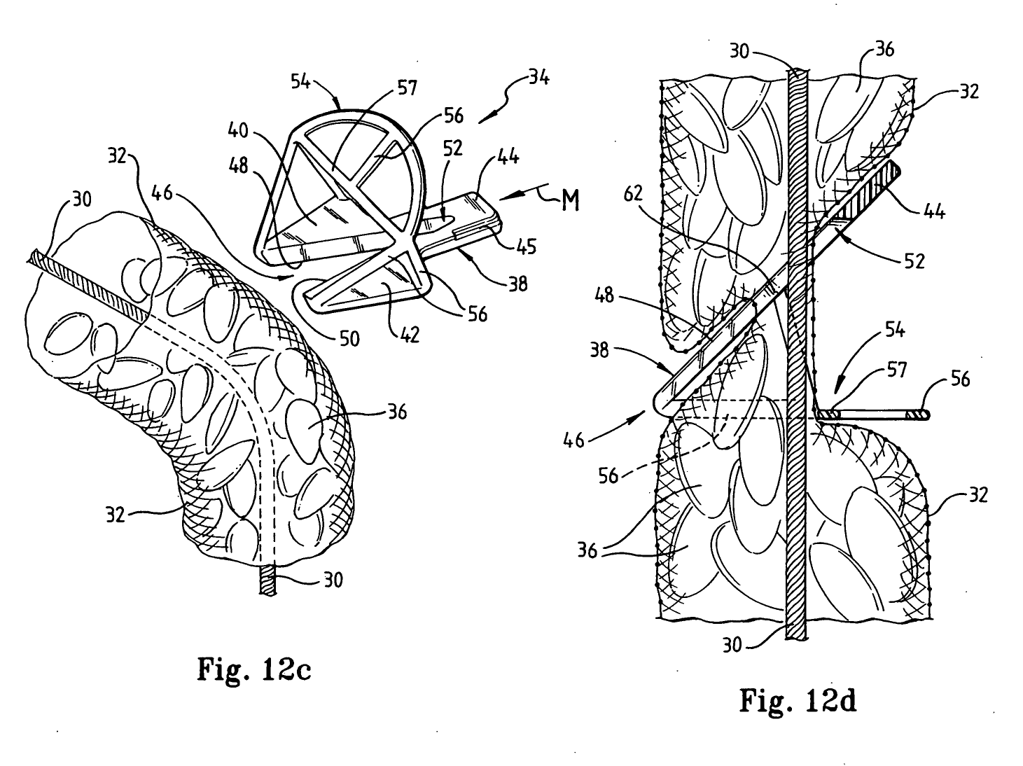

An aquaculture device 34 made in accordance with an eighth preferred embodiment of the invention and suitable for an automated application process to a growing line 12 is shown in FIGS. 12a to 12d. As seen in FIG. 12a, aquaculture device 34 is designed such that body 38 can sit flush on a surface prior to application of aquaculture device 34 to a growing line 12. This particular construction of aquaculture device 34 lends itself to an automated application process as the flush design of body 38, incorporating inwardly tapered slot 46, provides a means by which aquaculture device 34 can be driven toward and attached to (by the same action) growing line 12.

The embodiment of aquaculture device 34 of FIGS. 12a to 12d includes a number of features as are common to previous embodiments and, as such, these features will not be discussed in detail. Where the aquaculture device 34 of this embodiment differs from previous embodiments, other than the preferred flat design of body 38, is that aquaculture device 34 includes a pair of push-arm recesses 43,45 and a growing line engaging support 57. As can be best seen in FIG. 12b, push-arm recesses 43,45 are disposed on either side of intersection portion 44 of body 38. These recesses 43,45 are included so that, if desired, aquaculture device 34 may be mechanically driven by a cooperating push-arm of any suitable automated mechanical machine. In use a push-arm (not shown) can engage aquaculture device 34 at intersection portion 44, about push-arm recesses 43,45. Force applied by a push-arm (not shown) may then act against the rear of intersection portion 44. Recesses 43,45 assist with correct alignment of aquaculture device 34 during such an automated application process.

Growing line engaging support 57 is part of support portion 54 and extends substantially perpendicular to inwardly tapered slot 46 of aquaculture device 34, between support skirt 56. Growing line engaging support 57 provides additional support to aquaculture device 34 when the same is attached to growing line 12 (FIG. 12d) by pressing against mesh net 32 towards core growing rope 30. This additional support provided by growing line engaging support 57 assists against pivotal movement of aquaculture device 34 relative to growing line 12 when the same is exposed to mollusc growing arrangement 10.

A process of attaching aquaculture device 34 of FIGS. 12a to 12b to a growing line 12, embodied as a growing rope 30 which has been socked with a mesh net 32, is now described with reference to FIGS. 12c & 12d. In a first stage of application (FIG. 12c) aquaculture device 34 is positioned relative to growing line 12 such that body 38 is oriented downwards and inwardly tapered slot 46 is facing growing line 12 ready for application. When growing line 12 is appropriately positioned and maintained at a desired location ready for attachment of an aquaculture device 34, aquaculture device 34 is then driven by any suitable means, for example a push-arm (not shown), in the direction of arrow M (FIG. 12c). As aquaculture device 34 is driven toward growing line 12, in the direction of arrow M, growing line 12 travels inwardly of tapered slot 46 which compresses mesh net 32 about growing rope 30 and, at about the same time, parts or slices mussels 36 in the vicinity of opposed slot sides 48,50. This slicing or parting action clears a track to further provide a path for aquaculture device 34 to facilitate attachment. After appropriate force has been applied and growing line 12 has travelled through cleat-like raised sections 60,62 into engagement with opposed slot sides 48,50 at or near apex 52, aquaculture device 34 is securely attached at a desired location to growing line 12 (FIG. 12d). When exposed to, for example, mollusc growing arrangement 10, growing line 12, having aquaculture device 34 affixed thereto, is suspended in a reverse manner relative to the orientation of the same when aquaculture device 34 was applied (FIG. 12c), so that intersection portion 44 is facing upwardly of the vertically suspended growing line 12. Thus, when exposed to mollusc growing arrangement 10, inwardly tapered slot 46 of aquaculture device 34 is positioned such that increased weight acting on aquaculture device 34 will ensure that growing line 12 is driven further into inwardly tapered slot 46, maintaining attachment thereto.

As can be seen in FIG. 12d, when attached to growing line 12 growing line engaging support 57 of aquaculture device 34 acts against growing rope 30 whilst maintaining mesh net 32 pressed against the same.

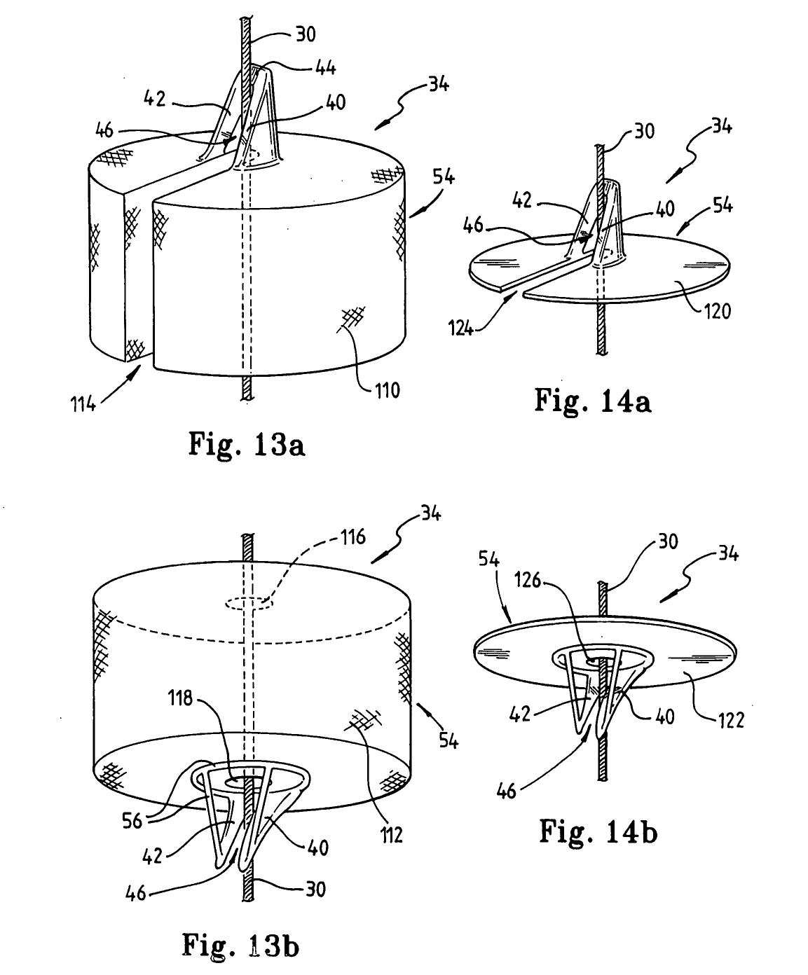

In FIGS. 13a & 13b there are shown an aquaculture device 34 made in accordance with ninth and tenth preferred embodiments of the invention. Here, aquaculture devices 34 include support portions 54 designed as cage-like structures 110,112. In FIG. 13a cage structure 110 includes a cage slot 114 which cooperates with inwardly tapered slot 46 of aquaculture device 34. In use growing line 12, which is embodied as only including a growing rope 30, is inserted into cage slot 114 and moved inwardly of cage 110 into engagement with inwardly tapered slot 46. Appropriately applied force against growing rope 30 then facilitates wedged engagement of growing rope 30 between opposed slot sides 48,50, in the same manner as already described with reference to the previous embodiments.

In FIG. 13b, instead of cage structure 112 incorporating a cage slot 114, cage structure 112 includes cage openings 116,118 that allow growing rope 30 to be passed through cage structure 112 to facilitate attachment of the same to growing rope 30. In use, growing rope 30 is threaded through cage openings 116,118 and into tapered slot 46. Once correctly positioned relative to growing rope 30, force is applied in order to wedge growing rope 30 into tapered slot 46 as before described.

In FIGS. 14a & 14b there are shown aquaculture devices 34 made in accordance with eleventh and twelfth preferred embodiments of the invention. The embodiment of FIG. 14a is similar to that of FIG. 13a, but therein aquaculture device 34 includes a support portion 54 designed as a support plate or disc 120, instead of a cage structure 110. The same applies with regard to the embodiment of FIG. 14b, as compared with that of FIG. 13b, wherein aquaculture device 34 of FIG. 14b includes a support portion 54 designed as a support plate or disc 122, instead of support cage structure 112. Attachment of either aquaculture devices 34 of FIGS. 14a & 14b occurs in a similar manner to that previously described, in cooperation with a plate slot 124 or plate opening 126 respectively.

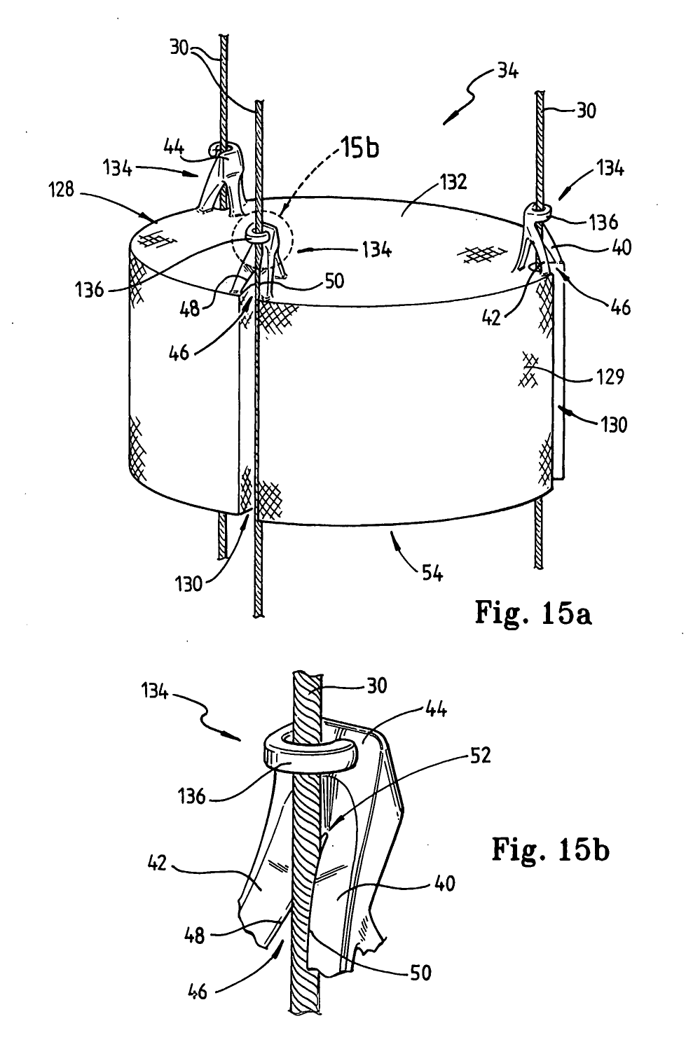

An aquaculture device 34 made in accordance with a final preferred embodiment of the invention is shown in FIGS. 15a & 15b attached to three growing ropes 30 being used in combination as growing line 12. Here, aquaculture device 34 includes a support portion 54 designed as a cage structure 128. On the wall 129 of cage structure 128 there are included three wall slots 130, each open to the periphery of cage structure 128 to facilitate insertion of three growing ropes 30 therein. Arranged on the top 132 of cage structure 128 are three attachment body portions 134, each of which include features common to previous embodiments. Body portions 134 each have an inwardly tapered slot arrangement 46 that is positioned in cooperating relationship with wall slots 130 such that growing ropes 30 may be introduced into wall slots 130 and into engagement with inwardly tapered slots 46 provided by respective body portions 134.

In FIG. 15a, and shown in enlarged view in FIG. 15b, body portions 134 each include a hook member 136 located and joined to body portions 134 on intersection portion 44. Hook members 136 are positioned such that growing lines 30 can be inserted behind hook members 136 between intersection portions 44 and partially enclosed thereby. Hook members 136 provide a means for substantially eliminating the likelihood of a growing rope 30 being dislodged from its respective tapered slot 46 when aquaculture device 34 is attached to all three growing ropes 30 and exposed to a growing environment.

Although only specific examples of suitable aquaculture devices and their application have been described, it is to be understood that many other devices, each including the tapered arrangement of the invention, could be applied to many other areas of aquaculture, for example, scallop, fish or oyster cultivation.

It should also be understood that an aquaculture device made in accordance with the invention may consist of any number of overlapping features of the above embodiments, the design choice of the relevant parameters, components of each aquaculture device depending on the intended environment of use and the specific needs of each application.

The present invention therefore provides a useful solution to problems previously discussed in relation to aquaculture support devices including conventional skewer attachment means and those employed in the prior art. Many related variations of an aquaculture device are therefore provided, each utilising a tapered slot arrangement to facilitate a wedge-like attachment to growing lines. The invention aims to benefit from the characteristics of growing lines, such as rope, and their inherent pliability which is well suited for compression. As growing lines are introduced into the tapered slot and moved inwardly relative thereto, marine growth separation occurs and the tapered slot arrangement locates the growing line and facilitates attachment of the device to the same. As force is applied to the growing line inwardly of the slot, either by way of manually induced force or by way of force induced by marine growth, growing line compression occurs relative to the opposed sides of the tapered slot. As compression force increases the growing line is moved further inwardly of the slot which creates the desired wedging effect on the growing line. It is this wedging action that ensures that the device is secured to the growing line. If the device is embodied with an inclined taper arrangement, the incline will assist the wedging action when weight increases on the body of the device over time.

If a device according to the invention is used with a growing line that is either a mesh sock or a mesh sock applied over a growing rope, the taper attachment of the device facilitates net compression, mussel separation and (if a rope is also used) location of the growing rope within the mesh sock. Thus, in cases where a rope is socked with a mesh net, it is not necessary to first locate the internal rope (which is sometimes hidden) to provide the desired attachment, as the taper arrangement will ensure that the rope is located and that the mesh net is compressed around the rope as force is applied.

The invention solves the inherent problems associated with conventional skewer means of attachment and the limitations stated in terms of the located prior art. The tapered slot arrangement ensures firm attachment to growing lines at fixed locations. The problems of skewer rotation within the rope or slip of the device relative to the growing line are negated as the wedging force applied to the growing line substantially eliminates any rotation or slip relative to the line.

The present invention therefore improves on previous means of attachment to a growing line, and deals with the problems associated with the environment of aquaculture, ease of attachment and detachment and furthermore specifically aims to permit mechanisation of application of such devices to growing lines. Many previous attempts to create improved aquaculture devices incorporating means for attachment to vertically suspended growing lines fail when applied in an aquaculture growing environment. Aquaculture devices are generally exposed to the growing environment (water) for long periods of time, up to a year or more. This long term exposure can render many devices ineffective. The effect of tide and wave action during storms can dislodge devices, cause rotation or slip, etc, and amplify the slide off effect. Weight accumulation over the growing period on the growing lines and devices attached thereto can stretch the growing lines, reducing their diameter. Thus any attachment means must be able to compensate for these changing properties, otherwise failure and resulting crop loss will occur. The tapered arrangement of the present invention can be used with growing lines of varying diameters, meaning that cheaper growing lines can be utilised in the harvesting operation. If a line should stretch when a device is attached thereto the taper will accommodate or compensate by further wedging the line into the slot by way of the force created by the weight on the device.

The taper arrangement makes it possible to automate the application process. Previously the skewering act of other means could not be mechanised, as the person locating the skewer had to physically locate the visually hidden growing rope internally of the mesh sock. Such a process does not lend itself to automation. The act of securing devices made in accordance with the present invention makes automation simplified in that a device can simply be applied by firmly pushing the device against a growing line that is maintained in a suitable manner. The taper arrangement ensures correct alignment of the growing line, rope, net, etc, and facilitates secure attachment thereto.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

1. An aquaculture device comprising;
a body, said body having at least one inwardly tapered slot for receiving at least one elongate support means, whereby said at least one elongate support means is adapted to be inserted through said body into said at least one inwardly tapered slot and, in use, to be wedged between opposed sides of said at least one inwardly tapered slot in order to attach said aquaculture device at a predetermined location on said at least one elongate support means.

2. The aquaculture device as claimed in claim 1, wherein said at least one elongate support means is adapted to be suspended below the surface of water in order to support and/or grow thereon a plurality of molluscs.

3. The aquaculture device as claimed in claim 2, wherein said body is adapted to provide an attachment surface and/or support area for supporting thereon said molluscs as they grow.

4. The aquaculture device as claimed in claim 1, wherein said body has a configuration, or is further attached to an additional body that has a configuration, selected from one or more of the following group: a planar support plate, a disc-shaped support plate, a support structure incorporating at least one protrusion, a support structure incorporating at least one ring-like support area, and/or a cage-like support structure.

5. The aquaculture device as claimed in claim 1, wherein said at least one inwardly tapered slot is open at one end to a perimeter of said body to enable ease of introduction of said at least one elongate support means therein.

6. The aquaculture device as claimed in claim 1, wherein said at least one inwardly tapered slot is closed at both ends such that said at least one elongate support means must be threaded into said at least one inwardly tapered slot.

7. The aquaculture device as claimed in claim 1, wherein said at least one inwardly tapered slot is inclined relative to said at least one elongate support means such that, in use, an apex of said at least one inwardly tapered slot is positioned higher relative to a broader end thereof.

8. The aquaculture device as claimed in claim 2, wherein said opposed sides of said at least one inwardly tapered slot are at least initially narrow in width so as to provide a means, in use, for slicing and/or parting molluscs present in the vicinity of an attachment area on said at least one elongate support means to assist with attaching said aquaculture device at said predetermined location on said at least one elongate support means.

9. The aquaculture device as claimed in claim 2, further comprising at least one wedge means arranged within said inwardly tapered slot, integral with or attached to at least one of said opposed sides of said at least one inwardly tapered slot.

10. The aquaculture device as claimed in claim 9, wherein said at least one wedge means is adapted, in use, to provide an additional means of retaining said at least one elongate support means within said at least one inwardly tapered slot.

11. The aquaculture device as claimed in claim 10, wherein said at least one wedge means is at least initially narrow in width in a removal direction of said aquaculture device.

12. The aquaculture device as claimed in claim 11, wherein said at least one wedge means is adapted, in use, to provide a means of assisting with dislodgment and removal of said aquaculture device from said at least one elongate support means by slicing and/or parting molluscs present in a detachment area relative to said removal direction of said aquaculture device.

13. The aquaculture device as claimed in claim 1, further comprising additional means selected from one or more of the following group: teeth, clips, hooks and/or releasably attachable locking arms, said additional means disposed on or near at least one of said opposed sides of said at least one inwardly tapered slot in order to retain or lock said at least one elongate support means within said at least one inwardly tapered slot.

14. The aquaculture device as claimed in claim 1, further comprising at least one skewer-like projection disposed within or near said at least one inwardly tapered slot such that, in use, when said at least one elongate support means is wedged between said opposing sides of said at least one inwardly tapered slot, said at least one elongate support means is additionally skewered by said at least one skewer-like projection.

15. The aquaculture device as claimed in claim 1, wherein said at least one elongate support means is selected from one or more of the following: any suitable rope, any suitable rope that is socked within any suitable net, and/or any suitable sock-like net.

16. The aquaculture device as claimed in claim 1, comprising one inwardly tapered slot for attaching said aquaculture device to one elongate support means at said predetermined location.

17. The aquaculture device as claimed in claim 2, comprising at least two inwardly tapered slots for attaching said aquaculture device to at least two elongate support means simultaneously.

18. The aquaculture device as claimed in claim 17, wherein said aquaculture device is a cage-like structure adapted to provide a substantially enclosed culture area for harvesting said molluscs.

19. The aquaculture device as claimed in claim 2, wherein said molluscs are mussels or oysters.

20. A method of attaching at least one aquaculture device to at least one elongate support means, said at least one aquaculture device having a body including at least one inwardly tapered slot for receiving said at least one elongate support means therein, said method comprising the steps of:
providing said at least one elongate support means;
providing said at least one aquaculture device; and
attaching said at least one aquaculture device to said at least one elongate support means at any predefined fixed location, wherein said at least one aquaculture device is secured to said at least one elongate support means by inserting said at least one elongate support means into said at least one inwardly tapered slot and wedging said at least one elongate support means between opposing sides of said at least one inwardly tapered slot.

21. The method as claimed in claim 20, wherein said at least one aquaculture device is attached to said at least one elongate support means by an automated application process.

22. An aquaculture growing assembly, comprising: at least one elongate support means to support and/or grow thereon a plurality of molluscs; and
at least one aquaculture device having a body including at least one inwardly tapered slot for receiving said at least one elongate support means therein;
whereby said at least one elongate support means is adapted to be inserted through said body into said at least one inwardly tapered slot and, in use, to be wedged between opposed sides of said at least one inwardly tapered slot in order to attach said aquaculture device at a predetermined location on said at least one elongate support means, and wherein said at least one aquaculture device is/are adapted to provide an attachment surface and/or support area for supporting said molluscs as they grow.

23. The aquaculture growing assembly as claimed in claim 22, wherein said molluscs are mussels or oysters.

24. (canceled)

25. (canceled)
